(19) United States
(12) Patent Application Publication
(10) Pub. No.: US 2005/0091232 A1
(43) Pub. Date: Apr. 28, 2005

(54) Methods and systems for attaching keywords to images based on database statistics

(75) Inventors: Reiner Eschbach, Webster, NY (US); William A. Fuss, Rochester, NY (US)

Correspondence Address: Ortiz & Lopez, PLLC, P.O. Box 4484, Albuquerque, NM, 87196-4484, US

(73) Assignee: Xerox Corporation

(21) Appl. No.: 10/693,163

(22) Filed: Oct. 23, 2003

(51) Int. Cl. G06F 7/00

(52) U.S. Cl. 707/100

(57) ABSTRACT

Methods and systems for adding identifying keywords to images stored within a database. A new image is compared to other images stored in a database using content based image retrieval methods. A user is automatically offered a set of keywords associated with stored images that most closely match the new image based on the comparison. The user can accept keywords contained in the offer or enter alternative keywords for the new image. A system can include a database adapted for storing images, a content based image retrieval module for providing text-associated image archiving, image management and image retrieval capabilities, database statistics module for providing statistical analysis regarding the number and type of images and metadata stored in the database, and a user interface (UI) adapted for providing user intervention during image archiving and further enables user acceptance of system suggestions, user selection of system suggestions, and enables user entry of user-provided keywords for association with images.

### TECHNICAL FIELD

Embodiments of the present invention generally relate to data and database management, such as manipulation, archiving and retrieval of documents containing text and images. Embodiments of the present invention also relate to methods for associating keywords to images. More particularly, the embodiments relate to utilizing of database statistics and user intervention for attaching keywords to digital images prior, during or after their storage in a database.

### BACKGROUND OF THE INVENTION

Retrieving most documents from a large database is relatively easy if the documents are present in a text readable form such as html, XML, etc., or if appropriate keywords are attached where images or other non-textual data are involved. Finding images in a large image database, however, is a problem because the approach of using a simple text string in searching for and identifying text-based documents within image databases cannot currently be performed for images without accurate identifying text. This identifying text is commonly referred to as meta-data, keyword, tag, or the like.

In order to find images in an image database, keywords have to be attached to images stored in the image database. Attaching keywords to images at the time that they are loaded into an image database is a rational approach to archiving. Unfortunately, such methods are almost never done because keyword attachment is considered cumbersome, time consuming, and generally inaccurate or inconsistent. The process of archiving images for storage in a database is especially susceptible to error where consistent or uniform labeling or identification schemes are not in use because images, unlike textual documents, cannot benefit from deep content or textual string searches to identify data of interest, despite inaccurate or inconsistent labeling.

Current approaches to content based image retrieval are error prone or extremely limited in their applicability (e.g., searching for porcelain patterns in an ancient porcelain database, or trademark symbols in images Currently, the only known method that allows images to efficiently be located in a database is by searching for auxiliary, text-based information associated with images. Unfortunately, there is seldom consistency in the type of words used in association with images, or of the type of images associated with words. This inconsistency leads to frustration and difficulty when database content users search database for specific images or image-types.

What is needed are methods and systems that enable images to be easily searched and retrieved while still using keywords in association with images stored, or to be stored, within databases.

### BRIEF SUMMARY

Aspects of the present invention related to methods and systems for identifying and attaching keywords to images for storage in a database using association with previously stored images of a similar genre are now disclosed.

It is a feature of the present invention to provide systems and methods that enable keyword association and user intervention with images stored in databases.

It is another feature of the present invention to provide improved procedures for assigning keywords to images based on prior image keyword associations utilized within a database system.

In accordance with a preferred embodiment of the present invention, a new image is compared to other images stored in a database using content based image retrieval methods. The user is automatically offered a set of keywords associated with stored images that most closely match the new image based on the comparison. The user can then accept keywords contained in the offer or enter alternative keywords for the new image. Once a selection is made by the user, the new image can be stored.

In accordance with another preferred embodiment of the present invention, an image database management system is provided. A content based image retrieval module in association with a database is adapted for providing the system image archiving, image data management and image retrieval capabilities. The system includes a database, content based image retrieval (CBIR) module, a database statistics module, and a user interface (UI) adapted for providing user intervention during image archiving that enables acceptance of system suggestions in combination with entry of user-provided keywords.

### BRIEF DESCRIPTION OF THE DRAWINGS

The accompanying figures, in which like reference numerals refer to identical or functionally-similar elements throughout the separate views and which are incorporated in and form part of the specification, further illustrate embodiments of the present invention.

FIG. 1 illustrates a schematic projection of a image database management system in accordance with features of the present invention;

FIG. 2 illustrates a block flow diagram illustrating methods for using an image database management system;

FIG. 3 illustrates part of a user interface including display and means for selecting image-related words; and

FIG. 4 illustrates a UI capable of supporting many of the logical operations and methods described with respect to FIGS. 1-3, and also in accordance with preferred embodiments of the present invention.

### DETAILED DESCRIPTION OF THE INVENTION

The particular values and configurations discussed in these non-limiting examples can be varied and are cited merely to illustrate an embodiment of the present invention and are not intended to limit the scope of the invention.

Attaching keywords to images at the time that they are loaded into an image database is a rational approach to archiving visual data. Adding auxiliary data to a content based image retrieval system, however, can greatly improve the applicability of content based image retrieval in certain scenarios. The creation of an image library within a database, either at personal or company-wide levels will be aided by semi-automating the process to create keywords. Initially the proposed system takes the same amount of time as is currently being used to archive image-related data in a normal image library system. With the establishment of categories and keywords, however, a high hit-ratio will be obtained for the keywords and user interaction can eventually be reduced to a simple procedure of accepting and/or correcting keywords used during ongoing archiving and retrieval of images.

Although attaching keywords at the time of original image storage into the image database is the preferred scenario, it has to be understood that the system described can alternatively be used to assign keywords to images already stored in the database by either identifying non-key worded images through an automatic, semi-automatic or manual process of identifying non-keyworded or not sufficiently keyworded images and treating them as “new” images for the keywording step. Here and in the following we will label all images that are not completely keyworded as “new” images, independent on the actual point in time in which they were initially entered into the database.

The present invention utilizes standard techniques of content based image retrieval as part of an image database management system to create metadata/keywords that can be used in subsequent queries to locate images. In this way, searchable keywords are created with minimal user intervention and error over time. The present system includes three components that interact in order to reduce user effort and error rates while developing an image database enhanced with the techniques of the present invention.

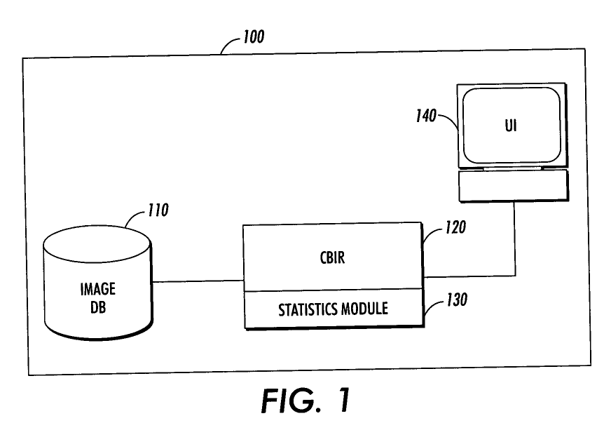

Referring to FIG. 1, the main components of a image database management system 100 are: a database 110, a content based image retrieval (CBIR) module 120, a database statistics module 130, and a user interface (UI) 140 that is adapted to enable users control over and participation in image archiving procedures through oversight and intervention.

In order to get a good estimate of the high level category, a CBIR module 120 having statistical capabilities 130 can be used. It should be appreciated that the chosen CBIR system can have all the error of a “normal” system and that no special requirement are currently being suggested or imposed that extend over current CBIR capabilities, but that the proposed system will benefit from any future improvements of CBIR systems. A CBIR system utilized by the present inventors will now be described as a basis for understanding what was used for the examples that will follow. The CBIR system included a color histogram based image proximity module (e.g., MPEG 7) and a skin, sky, grass, classifier built inside an enterprise server.

A standard CBIR system was enhanced using the present invention wherein the system is combined with image database statistic usage and user oversight and more input into the image archiving process than previously provided in the art. The combination of a CBIR, image statistics and full user intervention allows for a high rate of accuracy in image classifications during archiving procedures while simultaneously minimizing the necessary user intervention. It should be appreciated by those skilled in the art that the actual CBIR used with the present methods is of minor importance. It should be appreciated given the entire discussion that the present invention can be implemented using most CBIR based systems/modules available in the public domain.

An image database 110 is adapted to include a collection of images; but as with all collections, images contained in a database have some higher level commonalities. In a private home, for example, images are taken by the same person or small group of persons, therefore providing a strong commonality or consistency during image archiving because the relevant images only cover a few well-known themes. In larger information technology applications common to large enterprises, however, several themes prevail and must be considered during data archiving and management. But even in these scenarios, themes and variety of images are inherently limited to those interesting to the enterprise, like products, people and enterprise history. Overall, images that are already inside a database are a good statistical indication of the types of images that will be subsequently added to the database. So, for example, if the database contains images under the keywords <Family>, <Vacation>, <Friends>, <Cars>, etc., then the likelihood that the next image is a fit under those categories is extremely high. If the next image to be archived is of the category <Family>, and the past images that were archived in the <Family> category contained the following distribution:

| NAME | OCCURRENCE |
|---|---|
| Sascha | 17 |
| Melissa | 12 |
| Gela | 11 |
| Oma | 2 |
| Opa | 2 |

Then it is very likely that the people in the photo are Sascha, Melissa or Gela. If, however, the category <Friends> is selected for the same image with the distribution:

| NAME | OCCURRENCE |
|---|---|
| Peter | 12 |
| Heiko | 10 |
| Jeff | 10 |
| Melissa | 2 |
| Gela | 3 |
| Sascha | 1 |

It is then very likely that the people in the photo are not Sascha, Melissa or Gela, but rather are Peter, Heiko and/or Jeff. Thus, this simple statistical feature can be combined with CBIR in accordance with features of the present invention to form a hybrid keywording system where the CBIR is used to create a high likelihood of primary image category and database statistics are used to create finer scale keywords.

Assuming a new image is identified as “Image_New” and it belongs to the <Family> category, it may result in the following set of CBIR images sorted by proximity:

| | |
|---|---|
| Image_1 | <Family> |
| Image_2 | <Work> |
| Image_3 | <Family> |
| Image_4 | <Work> |
| Image_5 | <Family> |

In the CBIR environment, this set of retrieved images are considered a “close” association following the prior art methods in use. For a quality assessment, however, this retrieval result would be considered a “bad” association for the image. In a keyword scheme, where the task is not to retrieve specific images, but to assign correct keywords, the retrieval should be considered a “good” association and match. Here the statistics would indicate <Family> as being the strongest association, which is the correct classification under the present facts.

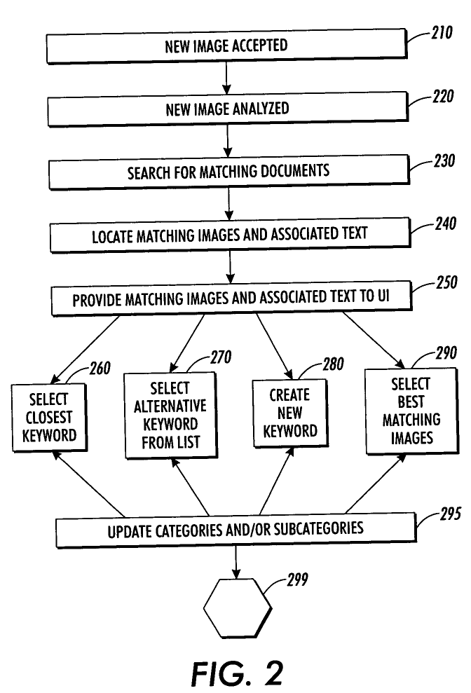

In accordance with embodiments of the present invention, several methods of user intervention and oversight are provided that can be incorporated into an image database management system. Referring to the flowchart shown in FIG. 2, an embodiment thereof provides several options for managing image-related data utilizing the present system. After a new image is entered into an image database system 210, the system analyzes the new image 220 and searches the database 230 for closely matching documents (e.g., image and text).

The system locates matching images and associated text 240 and presents the matching images and associated text to the user via a user interface (UI) 250. The user then has several options. The user can accept a keyword initially identified and suggested by the system 260 as the “best” or “closest” match after an image is loaded and evaluated, the keyword being suggested by the system as being the statistically best match or choice based on its analysis and comparison of database content when compared to the new image. The user can alternatively select a keyword from a list of keywords 270 presented by the system as other likely candidate keywords. The user can also create his/her own keyword(s) 280 for an image by selecting a new entry option from the UI. And finally, the user can select/deselect images retrieved by the CBIR 290 as the best candidates for a match statistically, thereby changing the keyword statistics associated with images of that genre or detailed characteristics. Once the category is accepted by the user, any categories, and/or sub-categories, are automatically updated by the system 295 according to the new images effect on the CBIR and database statistics. This places the “most likely” keyword(s) associated with entry of the new image to the top or into the top group of displayed keywords, again reducing user intervention. The process is then terminated 299 until a subsequent archiving session.

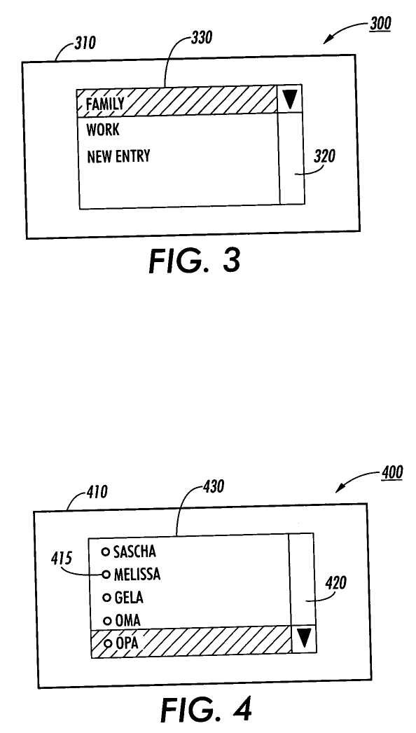

Referring to FIG. 3, an example of a basic UI 300 in accordance with features of the present invention is shown. The UI 200 can include a drop down menu 310, scroll bar 320 and keyword listing area 330 and other common elements. In accordance with aspects of the present invention, the most probable classification would likely be shown first (e.g., <Family>) in the keyword listing area 330, followed by the other classifications in descending order (e.g., <Work>). If more database classifications are displayed, even if they were not in the hit list, acceptance of a user-provided option would not be relevant. But where few listing are available, as may be the case with newly established image databases, the user can select the <New Entry> option from the keyword listing 330.

As new keywords are added to the system by users, the listing would grow, thereby necessitating use of the scroll bar 320 or arrow keys on a keyboard, which are both basic computer user operations well known in the art. The relevant point of novelty here is that the UI 300 and drop down menu 310 are dynamically created following the addition of new and probability of existing keywords. It should now be appreciated at this stage of the description that other indications can influence the probability calculation; for example, the use of new keywords for images previously entered into a database and the time images were entered. This makes use of the fact that images that are entered into the database at one point in time also have a high likelihood of belonging to the same or similar class.

Taking into consideration the previous example, the category drop-down in the drop down menu 310 for the new image being entered would look like the screen shot shown in FIG. 2 wherein <Family> is properly highlighted based on statistics (e.g., three “Family” hits, and two “Work” hits being indicated for the new image).

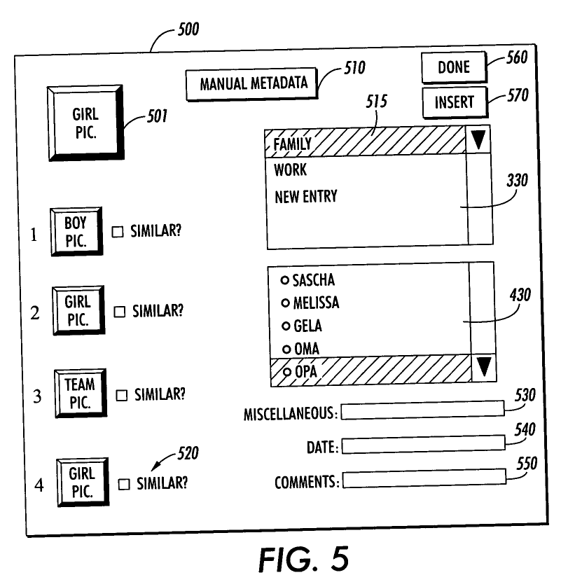

Following the foregoing description, the sub-category UI in accordance with providing an aspect of the present invention would look like the UI 400 shown in FIG. 4. The subcategory UI 400 also includes a drop-down menu 410 and is shown having simple check-circles 415 (or check-boxes) for selection of the names associated with the new image and also includes a drop-down menu control bar 420 to enable a user to scroll through a long list 430 of names within the sub-category.

Referring to FIG. 5, an example database entry UI 500 useful for image-based comparisons and selection is shown. A new image 501 being processed for initial storage in a database can be located near the top left portion of the UI 500. Also shown beneath the new image are four of the closest matching images, images 1-4. Three of the four closes matches have the category <Family> attached to them and feature pictures of individuals with various background scenes, scenes which can be filtered out using MPEG7 CBIR capabilities. The new image can thus be assigned the same keyword as images 1, 2, and 4, <Family>. Image 3 however, is classified as <Judo> and includes a team picture with a background scene. The new image 501 featuring a picture of a girl with a background scene caused retrieval of the other four displayed images 1-4 that were deemed by the system to be of the closest match to the new image. Accordingly, the correct keyword that would be derived by the system from the closest matching images would be <Family>.

In addition to the portion of the UI 500 shown in FIG. 5 for displaying new images and archived images, the UI can includes a manual metadata button 510, which enables the text entry field 515 associated with an interface like keyword listing 330 for entering manual data in association with the new image 501. Also included in the UI 500 are checkboxes 520, which allow the user to select images, retrieved by the system, that closely match the new image entered by the user. Fields can also optionally be provided for collection of miscellaneous information. The “Miscellaneous” field 530 allows a user to enter data association with a picture. The “Date” field 540 can also be entered in the UI 500 for providing additional data management solutions. A “Comments” field 550 allows user entry if additional image-related information, that does not have to be searchable or subject to statistical analysis by the system. An “Insert” button 560 can be selected in the UI 500 if a user wants to continue loading new images into the database. Another button, labeled “Done” 570, can be provided when a user wishes to terminate his archiving activity.

The most significant drawback from using the above-described invention is the need for an existing categorization protocol in the image database, which is necessary to facilitate subsequent keywording using the invention. If the initial set of images is not keyworded, subsequent images can not find any classification to become associated with and thus no labor savings is achieved. This problem can be addressed by seeding the database keywording with some generic keywords that are not specific to the current user, but rather based on a larger envisioned user group, or by having one person seed the database keywords prior to image database entries done by a larger group.

It should also be appreciated that various other alternatives, modifications, variations, improvements, equivalents, or substantial equivalents of the teachings herein that, for example, are or may be presently unforeseen, unappreciated, or subsequently arrived at the applicants or others are also intended to be encompassed by the claims and amendments thereto.

1. A method for adding identifying keywords to images stored within a database, comprising the steps of:
comparing a new image provided by a user to images stored in a database; and
automatically offering a user a set of keywords associated with stored images that most closely match the new image that is based on image comparison results derived from said step of comparing, wherein said offering is based on the time of entry for similar images and the number of occurrences of the similar images when compared to the new image that have been historically processed by the database as indicated by database statistics provided by a database statistics module.

2. The method of claim 1 further comprising the step of enabling the user to either accept keywords contained in the offer or enter alternative keywords for the new image.

3. The method of claim 2 further comprising the step of storing at the direction of the user the new image within the database together with keywords automatically offered to the user.

4. The method of claim 2 further comprising the step of storing at the direction of the user the new image within the database together with alternative keywords provided by the user.

5. The method of claim 2 further comprising the step of historically updating the database by recording said storing of the new image within the database together with keywords automatically offered to the user as another occurrence associated with similar images historically processed by the database including updating the time of said storage.

6. The method of claim 2 further comprising the step of historically updating the database by recording said storing of the new image within the database together with alternative keywords provided by the user as a new image occurrence processed by the database including updating the time of said storage

7. The method of claim 2 wherein a user's selection to store a new image having alternative keywords will provide the user with data entry fields associated with database storage processes for the entry of alternative keywords into the database wherein the data entry fields accept alternative keywords associated with the new image being entered by the user.

8. The method of claim 7 further comprising the step of storing at the direction of the user the new image within the database together with the alternative keywords.

9. The method of claim 8 including a step wherein new subgroups are generated after the step of storing the new image and alternative keywords within the database.

10. A method for adding identifying keywords to images stored within a database, comprising:
(a) comparing a new image provided by a user to images stored in a database;
(b) automatically offering a user a set of keywords associated with stored images that most closely match the new image that is based on database statistics provided by a database statistics module and on image comparison as provided in step (a); and
(c) enabling the user to either accept keywords contained in the offer or to enter alternative keywords for the new image.

11. The method of claim 10 further comprising the step of storing at the direction of the user the new image within the database together with keywords automatically offered to the user.

12. The method of claim 10 further comprising the step of storing at the direction of the user the new image together with alternative keywords provided by the user within the database.

13. The method of claim 11 further comprising the step of historically updating the database by recording said storing of the new image within the database together with keywords automatically offered to the user as another occurrence associated with similar images historically processed by the database including updating the time of said storage.

14. The method of claim 12 further comprising the step of historically updating the database by recording said storing of the new image and the alternative keywords within the database as a new image occurrence processed by the database including updating the time of said storage.

15. The method of claim 14 wherein a user's selection to store a new image having alternative keywords will provide the user with data entry fields associated with database storage processes for alternative keywords wherein the data entry fields accept new images and the alternative keywords associated provided by the user.

16. The method of claim 15 further comprising the step of storing at the direction of the user the new image and the alternative keywords within the database.

17. The method of claim 16 including a step wherein new subgroups are generated after the step of storing the new image and alternative keywords within the database.

18. An image database archiving system, comprising:
a database adapted for storing images;
a content-based image retrieval module in association with the database and adapted for providing text-associated image archiving, image management and image retrieval capabilities;
a database statistics module for providing statistical data regarding the number and type of images and metadata stored in the database wherein the database statistics module is updated whenever an image is added to or removed from the database such that the database statistics module remains current; and
a user interface (UI) adapted for providing user intervention during image archiving and further enables user acceptance of system suggestions, user selection of system suggestions, and enables user entry of user-provided keywords for association with images.

19. The system of claim 18 wherein the database statistics module in combination with user action at the user interface provides users control over image archiving.

20. The system of claim 18 wherein the database statistics module enables historical updating of the database.
